(19) United States
(12) Patent Application Publication
(10) Pub. No.: US 2026/0115811 A1
(43) Pub. Date: Apr. 30, 2026

(54) MULTIDIRECTIONAL POWER DRILL WITH INTEGRATED STUD FINDER

(71) Applicant: Treyvon Jackson, New Port Richey, FL (US)

(72) Inventor: Treyvon Jackson, New Port Richey, FL (US)

(21) Appl. No.: 18/928,317

(22) Filed: Oct. 28, 2024

(51) Int. Cl. B23B 45/02; B23B 49/00

(52) U.S. Cl. CPC B23B 45/02; B23B 49/00

(57) ABSTRACT

A drilling apparatus comprising a top body that extends horizontally, a top socket configured underneath the top body to allow for multidirectional movement, and a ball joint positioned beneath the top socket. This ball joint is in contact with the top socket and enables 180-degree horizontal rotation and 90-degree vertical tilt. Additionally, a bottom socket is configured underneath the ball joint to provide stability. The apparatus features a motor connected to a rotary output and includes a trigger switch or button located on a vertically aligned handle. An integrated stud finder, activated by a detachable accessory, allows users to quickly locate studs behind walls before drilling. This apparatus is configured to enhance maneuverability and user comfort, for use in a variety of professional and personal home improvement settings.

### TECHNICAL FIELD

The embodiments generally relate to power drills, and more specifically a multidirectional power drill with integrated stud finder.

### BACKGROUND

Traditional power drills often present challenges when used in confined spaces or awkward angles, leading to decreased user comfort and control. Standard drill designs typically feature fixed positions that limit flexibility, making it difficult for users to achieve optimal drilling angles. Furthermore, many existing drills lack integrated features that assist in locating structural elements, such as studs, which are essential for effective drilling in various applications.

The need for a more versatile power drill has become increasingly evident as Do-It-Yourself (DIY) projects and professional tasks demand greater adaptability. Enhancements in drill technology that allow for improved maneuverability and integrated functionality would significantly benefit users across a range of fields, including construction, woodworking, and home improvement.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein disclose a power drill comprising a top body including a drill motor and a drill head. A top socket is positioned on a bottom portion of the top body. A handle includes a bottom socket positioned on the top portion of the handle. A ball joint connects the top body and the handle to enable horizontal and vertical articulation of the top body. A stud finder is positioned to facilitate the identification of a location of a stud.

The drill features a motor connected to a rotary output and includes a trigger switch or button located on the handle. Additionally, the apparatus incorporates a built-in stud finder allowing users to accurately locate studs behind walls before drilling. This configuration allows for drilling at multiple angles and orientations, improving user comfort and operational efficiency.

Existing drills do not provide an articulating drill head, restricting the position in which the drill is used during operation. The present embodiments addresses these limitations by introducing a unique ball joint and socket mechanism, enabling 180-degree horizontal rotation and up to 90-degree vertical tilt. Additionally, the incorporation of a detachable stud finder enhances the drill's utility, making it an invaluable tool for both amateur and professional users.

In one aspect, the ball socket facilitates ambidextrous use of the multidirectional drilling apparatus by enabling omnidirectional articulation of the drill head.

In one aspect, the stud finder is in communication with an indicator to illuminate upon the detection of a stud.

In one aspect, a drill bit changing mechanism accepts a drill bit. The automatic drill bit changing mechanism may include a universal chuck integrated in the drill head which allows for the universal attachment to various sizes and configurations of drill bits and similar tools hands free.

In one aspect, the multifunctional drill is designed for ambidextrous use.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a side elevation view of the multidirectional power drill configured in a first position, according to some embodiments;

FIG. 2 illustrates an isometric view of the multidirectional power drill configured in a second position, according to some embodiments;

FIG. 3 illustrates a side view of the multifunctional power drill configured in a third position, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relates to a multifunctional drilling apparatus which includes a top body housing a drill motor and drill head. A top socket is positioned on a bottom portion of the top body and handle includes a bottom socket position on the top portion of the handle. A ball joint rotatably connects the top body to the handle to enable the horizontal and vertical articulation of the top body. A stud finder is positioned on the drilling apparatus to facilitate the identification of the location of a stud.

The incorporation of a ball joint enhances the user experience by enabling smooth rotational movement of the top body. This embodiment increases comfort during use, accommodating various drilling angles and positions. The ball joint also promotes ambidextrous operation. Users can effortlessly switch hands without compromising control or functionality.

The integration of a stud finder within the multifunctional drilling apparatus offers several benefits. By eliminating the need for an additional tool, users can save time and effort during their projects. The stud finder enhances precision, allowing users to accurately locate studs without trial and error, thus improving overall drilling efficiency and reducing the risk of damaging walls or other structures.

Alternative embodiments may include variations in the materials used for the top body or handle, adjustments to the ball joint mechanism for enhanced stability, or additional ergonomic features to further improve user comfort. These adaptations could cater to specific user preferences or particular application needs.

A removable battery is another notable feature of the drilling apparatus, providing users with the convenience of quick battery replacement. This design ensures that users can maintain optimal power levels during extended use without downtime for charging.

The multifunctional drilling apparatus also features an integrated bit recognition system that allows for easy interchangeability of drill bits. This system automatically detects when a drill bit is not properly fitted, prompting the user to replace it with a compatible one. This convenient feature ensures that users can quickly adapt to different drilling tasks without complications, enhancing the overall efficiency and functionality of the apparatus.

Other features of the apparatus may include an adjustable speed setting for the drill motor, an LED work light to illuminate the drilling area, and a built-in level to assist with accurate drilling alignment. These additions aim to provide a comprehensive tool for various drilling tasks, ensuring versatility and user satisfaction.

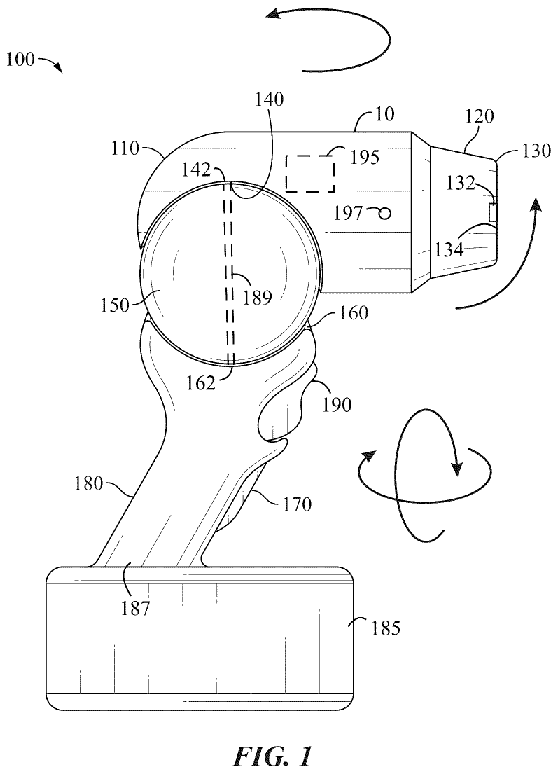

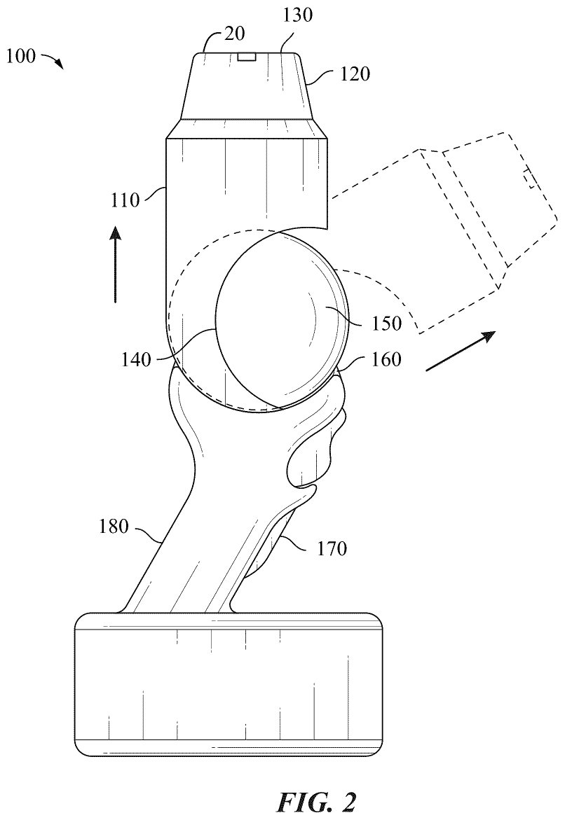

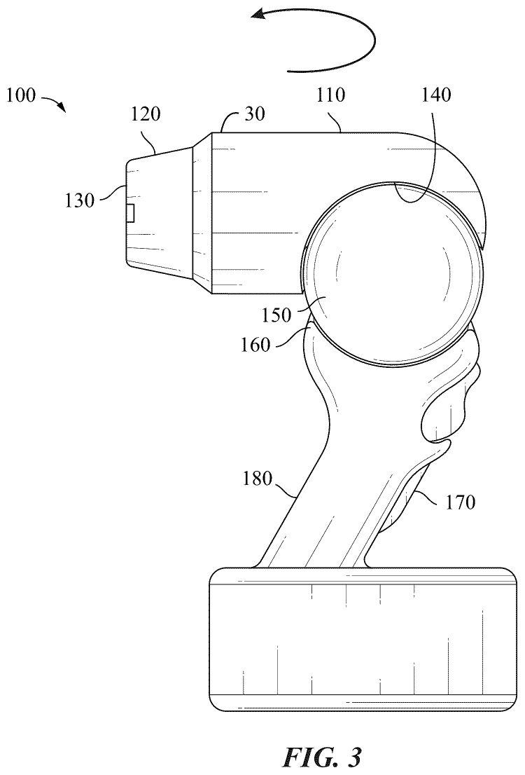

FIGS. 1-3 illustrate the multifunctional drilling apparatus, detailing the location and function of each numbered element within the design. Each figure captures distinct angles and configurations, showcasing the apparatus's versatility and functionality. In particular, FIG. 1 illustrates the multifunctional drill 100 in a first position 10, FIG. 2 illustrates the multifunctional drill 100 in a second position 20, and FIG. 3 illustrates the multifunctional drill 100 in a third position 30.

In reference to FIG. 1, the multifunctional drill 100, is depicted with specific components highlighted. The top body 110, houses the drill motor and integrates the drill head 120 and drill tip 130. The top socket 140 is positioned at the bottom 142 of the top body 110, connecting it to the handle 180. The ball joint 150 facilitates multidirectional movement of the top body, allowing it to articulate 90 degrees vertically and 180 degrees horizontally. The bottom socket 160, located at the top portion 162 of the handle 180, provides a secure attachment point. Additionally, the secondary safe lock trigger 170 is positioned for easy access, allowing the user to engage or disengage the motor to operate the drill via the on/off button 190 on the handle 180.

In further reference to FIG. 1, the multifunctional drill 100 includes a stud finder 195 provided within the top body 110 or provided within another region of the housing of the multifunctional drill 100. An indicator 197 to indicate the presence of a stud detected by the stud finder 195. The indicator 197 may be an LED light which illuminates upon the detection of a stud. A battery 185 is removably attached to the bottom 187 of the handle 180 to provide electrical power to the drill head 120. The ball joint 150 includes a channel 189 which enables electrical wires to travel therethrough to deliver the electrical power from the battery 185 to the drill head 120.

A drill bit changing mechanism 134 positioned on the drill head 120 enables the operation of a universal chuck 132 which can releasably attach to various sizes and configurations of drill bits (not shown).

In one embodiment, a drill bit changing mechanism 134 positioned in the top body 110 enables the operation of a universal chuck 132 which can releasably attach to various sizes and configurations of drill bits (not shown).

In reference to FIG. 2, the multifunctional drill 100, the top body is shown positioned vertically. This view emphasizes the alignment of the top body 110 and its connection to the handle 180 through the ball joint 150. The vertical orientation highlights the stability and control offered by the apparatus during drilling tasks. The top socket 140 and bottom socket 160 maintain their respective roles, ensuring seamless connectivity as the user adjusts the position for various drilling angles.

In reference to FIG. 3, the multifunctional drill 100, the top body 110 is rotated in the opposite direction of that shown in FIG. 1. This figure showcases the apparatus's ability to transition smoothly between orientations, facilitated by the ball joint 150. The drill head 120 and drill tip 130 remain accessible, ensuring that the user can maintain control and precision regardless of the angle. The positioning of the top socket 140 and bottom socket 160 continues to provide robust support throughout the movement.

The user can transition between the positions shown in FIGS. 1-3 fluidly. The ball joint 150 allows the top body to rotate freely while maintaining stability. When the user engages the secondary safe lock trigger 170, they can enable or disable the drill head operation. The friction fit mechanism enables controlled adjustments, ensuring that the top body remains firmly in place when needed, while still allowing for smooth transitions between vertical and horizontal orientations.

During use, the user may utilize the stud finder feature of the drilling apparatus to identify the location of a stud behind a wall. The indicators signal the presence of a stud. This integrated feature provides visual and audible feedback, allowing users to locate studs without needing an additional tool. The seamless incorporation of the stud finder enhances the overall usability of the apparatus, streamlining the drilling process. Users can focus on their tasks with confidence, knowing that they can efficiently identify stud locations, further increasing the efficiency and effectiveness of their drilling efforts.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A multidirectional drilling apparatus, comprising:
a top body including a drill motor and a drill head;
a top socket positioned on a bottom portion of the top body;
a handle including a bottom socket positioned at a top portion of the handle;
a ball joint connecting the top body and the handle, the ball joint to enable the horizontal and vertical articulation of the top body;
a stud finder positioned to facilitate the identification of a location of a stud.

2. The multidirectional drilling apparatus of claim 1, wherein the ball joint facilitates ambidextrous use of the multidirectional drilling apparatus by enabling omnidirectional articulation of the drill head.

3. The multidirectional drilling apparatus of claim 1, further comprising an indicator in communication with the stud finder.

4. The multidirectional drilling apparatus of claim 1, wherein the stud finder is positioned in on the top body.

5. The multidirectional drilling apparatus of claim 1, further comprising:
a drill bit changing mechanism to accept a drill bit.

6. The multidirectional drilling apparatus of claim 5, wherein the drill bit changing mechanism includes a universal chuck integrated to the drill head.

7. The multidirectional drilling apparatus of claim 1, further comprising:
an ambidextrous grip attached to the handle.

8. A multidirectional drilling apparatus, comprising:
a top body including a drill motor and a drill head;
a top socket positioned on a bottom portion of the top body;
a handle including a bottom socket positioned at a top portion of the handle;
a ball joint connecting the top body and the handle, the ball joint to enable the horizontal and vertical articulation of the top body;
a secondary safe lock trigger to disable or enable operation of the drill head; and
a stud finder positioned to facilitate the identification of a location of a stud.

9. The multidirectional drilling apparatus of claim 8, wherein the ball joint facilitates ambidextrous use of the multidirectional drilling apparatus by enabling omnidirectional articulation of the drill head.

10. The multidirectional drilling apparatus of claim 9, further comprising an indicator in communication with the stud finder.

11. The multidirectional drilling apparatus of claim 10, wherein the stud finder is positioned in on the top body.

12. The multidirectional drilling apparatus of claim 11, further comprising:
a drill bit changing mechanism to accept a drill bit.

13. The multidirectional drilling apparatus of claim 12, wherein the drill bit changing mechanism includes a universal chuck integrated to the drill head.

14. The multidirectional drilling apparatus of claim 13, further comprising:
an ambidextrous grip attached to the handle.

15. An ambidextrous drilling apparatus comprising:
a top body including a drill motor and a drill head;
a top socket integrally molded to a bottom portion top body;
a handle including a bottom socket integrally molded to a top portion of the handle;
a ball joint connecting the top body and the handle, the ball joint to enable the horizontal and vertical articulation of the top body to facilitate ambidextrous use of the drilling apparatus;
a secondary safe lock trigger to disable or enable operation of the drill head;
a stud finder positioned to facilitate the identification of a location of a stud; and
a removable battery attached to a bottom of the handle.

16. The ambidextrous drilling apparatus of claim 15, wherein the ball joint enables the omnidirectional articulation of the top body.

17. The ambidextrous drilling apparatus of claim 15, wherein the ball joint includes a channel to receive electrical power therethrough to deliver power from the battery to the top body.

18. The ambidextrous drilling apparatus of claim 15, further comprising:
a button positioned on the handle to enable the ambidextrous operation of the drill.

19. The ambidextrous drilling apparatus of claim 15, further comprising:
a universal chuck positioned on a front portion of the drill head to connect and disconnect to a drill bit.

20. The ambidextrous drilling apparatus of claim 15, wherein the stud finder is in operable communication with an indicator to indicate the identification of the stud.
